(19) United States
(12) Patent Application Publication
(10) Pub. No.: US 2008/0193622 A1
(43) Pub. Date: Aug. 14, 2008

(54) Highly Aerated Confection

(75) Inventors: Josefin Haedelt, GB-York (GB); Peter Cooke, GB - Huntington (GB); Jeremy Hargreaves, GB - York (GB)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/913,025

(22) PCT Filed: May 19, 2006
(86) PCT No.: PCT/EP2006/004770

§ 371 Date: Oct. 29, 2007

(30) Foreign Application Priority Data
May 20, 2005 (EP) 05104299.2

(51) Int. Cl. A23G 9/46; A23G 9/20

(52) U.S. Cl. 426/572; 426/565

(57) ABSTRACT

This invention concerns a fat continuous phase confectionery material which is highly aerated and the method for producing it. The material has a very low density below 0.2 g/cm³ and at least equal to 0.1 g/cm³ with an improved soft texture and sensory properties. In the process, nitrogen or equivalent gas is incorporated into the confectionery material at an elevated pressure, the confectionery material deposited at a reduced pressure and then further expanded by reducing the pressure still further as the confectionery material cools.

### FIELD OF THE INVENTION

This invention relates to a fat-based confectionery material which is highly aerated and the method for producing it.

### BACKGROUND OF THE INVENTION

Aerated fat-based confectionery products are well known and there are a number of international aerated chocolate brands on the market such as Nestlé Aero® and Milka Luflée®.

A process for making aerated chocolate was described in 1935 in GB459583 (to Rowntree) which involves incorporating air or other gas in molten chocolate, for example by using a whisk, and then expanding the bubbles by reducing the pressure. The chocolate is cooled to set it.

Other processes to reduce the density of fat based confectionery products are now available. M. S. Jeffery [The Manufacturing Confectioner, November 1989 p 53-56] reviews techniques of chocolate aeration. In his introduction he notes that the process of aerating chocolate generally reduces its density from 1.3 to 0.4-0.7 g/cm³. In addition, Jeffery describes a process where air or another gas is incorporated into the fat phase as it is cooled and crystallized. Although this generally reduces the density to 0.7-0.8 g/cm³ he notes that by using a 1:1 mixture of glyceryl mono stearate and soya lecithin in the chocolate it is possible to reach densities as low as 0.2 g/cm³.

U.S. Pat. No. 4,272,558 discloses a process for producing a cellular chocolate where gas is incorporated into the chocolate under pressure. When the pressure is released, bubbles are formed in the chocolate which is then solidified by cooling.

Different gasses can be incorporated into chocolate. EP0575070 (p 4, lines 27-28) teaches that nitrogen produces finer bubbles than carbon dioxide in chocolate. When nitrogen or air is used to produce small bubbles not readily detected by the unaided human eye this is sometimes referred to as microaeration. A process for applying such microaerated chocolate as a coating is described in WO0064269.

In EP 0 230 763 (Morinaga & Co) the process combines incorporation of gas by agitation with cooling and expansion under a reduced pressure. Air, N₂, or CO₂ can be used. The density of confectionery products made by the process is between 0.23 and 0.48 g/cm³. EP 0 230 763 describes that when the density is lower than 0.23 g/cm³ large cavities emerge in the aerated chocolate and the product is too fragile to maintain its shape.

GB1490814 describes a “reverse phase” aerated chocolate where the continuous phase is a sugar glass. The resulting product has a density of 0.1-0.3 g/cm³.but the sugar glass gives it a crisp texture uncharacteristic of chocolate.

Some aerated chocolate products can give a dry feeling in the mouth. However, with a lower density aerated chocolate there is only a very small amount of material in the mouth and so it melts rapidly. This overcomes the problem of a dry mouthfeel.

There is a need to find a new method for the manufacture of fat-based confectionery products with a continuous fat phase which are highly aerated (density lower than the existing aerated products) but have an essentially uniform structure without large voids. These products should have a soft melting texture and, despite their very low density, should be resistant enough to maintain their shape and to be moulded to provide products with improved aspect and structure.

### SUMMARY OF THE INVENTION

This invention concerns a fat-based aerated confectionery material which is highly aerated and the method for producing it. The material has a very low density, below 0.2 g/cm³ and at least equal to 0.1 g/cm³ with an improved soft texture and sensory properties. In the process, nitrogen gas is incorporated into the fat-based aerated confectionery material at an elevated pressure, the material deposited at a reduced pressure and then further expanded by reducing the pressure still further as the material cools.

### FIGURES

FIG. 1 shows slices through CT X-ray tomography data of a chocolate product manufactured according to example 1, comparing the effect of using nitrogen gas with that of using carbon dioxide.

FIG. 2 shows a highly aerated chocolate of the invention, aerated with nitrogen and sandwiched between two wafers.

### DETAILED DESCRIPTION OF THE INVENTION

The present invention relates to a fat-based confectionery material with a continuous fat phase and the method for producing it. In this invention, “fat-based confectionery material” should be understood as referring to a dark, milk or white chocolate, or to chocolate analogues containing; milk fat, milk fat replacers, cocoa butter replacers, cocoa butter substitutes, cocoa butter equivalents, non metabolizable fats or any mixture thereof; or Caramac® sold by Nestle comprising non-cocoa butter fats, sugar and milk; nut pastes such as peanut butter and fat; and/or praline among others. Fat-based confectionery materials may include sugar, milk derived components, fat and solids from vegetable or cocoa sources, or any other usual ingredient for chocolate such as lecithin for example, in different proportions.

Pressures in this document are referred to in units of bar, where 1 bar=100,000 Pa. In everyday use, pressure is often measured with reference to atmospheric pressure; this is “gauge pressure”. For example if someone says that their car tyres are pressured up to 2.3 bar they actually mean bar gauge: the pressure in the tyre is really 3.3 bar, but only 2.3 bar above atmospheric pressure. For convenience all pressures in this document are given as absolute pressures unless stated otherwise. So 0 bar is a complete vacuum while atmospheric pressure is around 1 bar. For small pressure units mbar is used, where 1000 mbar is one bar.

In our invention the fat-based confectionery material with a continuous fat phase is “highly aerated”, that is to say the density of the material is very low. The material comprises many bubbles filled with gas and the proportion of gas volume in the product is very high. Nevertheless the material in our invention has a stable structure: it does not break or crumble when picked up by hand, it is able to maintain its shape, and can be layered between wafers or moulded into a chocolate shell.

The present invention discloses a fat-based confectionery material with a continuous fat phase which has a very low density, below 0.2 g/cm³ and at least equal to 0.1 g/cm³. Preferably, the density is comprised between 0.15 and 0.19 g/cm³, and even more preferably between 0.17 to 0.19 g/cm³. This represents 84 to 92% of the volume being gas. The mean bubble diameter is between 0.3 and 0.7 mm, preferably between 0.4 and 0.6, measured according to the method described in example 3. Although some of bubbles may be interconnected, less than 10% of the volume is occupied by large voids, preferably 8% at most. Large voids are to be understood as spaces with a volume greater than 9 mm³.

The fat based confectionery material with a continuous fat phase according to our invention differs in aspect and sensory properties from any known confectionery product. Indeed the material is lighter coloured than its equivalent in un-aerated form and looks more like a bakery product such as a cake rather than a traditional aerated chocolate product.

Carbon dioxide is known to produce large bubbles when aerating chocolate while nitrogen produces a microaeration. This would lead someone attempting to minimize density in a fat based confectionery product to use carbon dioxide. Surprisingly, we found that by incorporating N₂ under pressure and then applying a reduced pressure as the confectionery material cools we could create a confectionery material with this appealing cake-like structure. Moreover the confectionery material has unique properties including a silky texture, very soft mouth-feel and very quick melt. Using carbon dioxide instead of nitrogen gave an unsuccessful result as the material contained large voids and the density could not be significantly reduced without the resulting material falling apart.

Other gasses give an equivalent result to that obtained with nitrogen. These include air and argon which will both lead to a microaerated structure when chocolate is aerated by gas under pressure, for example using the process of U.S. Pat. No. 4,272,558. Without wishing to be bound by theory, we believe this is due to the gasses' solubilities in chocolate. For example, nitrogen, air and argon all produce a microaerated structure and have lower solubility in chocolate than carbon dioxide and nitrous oxide which both lead to macro-aeration.

The highly aerated fat based confectionery material with a continuous fat phase of the invention can be used as such or can be moulded within a chocolate shell, used as a layer between wafers (FIG. 2), or as a filling of another product for instance.

The present invention also discloses a method to produce a highly aerated fat based confectionery material with a continuous fat phase. The process incorporates gas into the confectionery material with a continuous fat phase at an elevated pressure, allows the confectionery material to expand at a lower pressure and then an even lower pressure is applied as the confectionery material cools and solidifies.

In a first step a fat based confectionery material with a continuous fat phase is aerated by dissolving nitrogen or equivalent gas (such as air or argon) using an elevated pressure. The temperature of this fat-based confectionery material is between 22° C. to 42° C., preferably between 25° C. to 37° C., and more preferably between 27° C. to 33° C. For temperable fat-based confectionery the material will have been tempered. The elevated pressure is preferably between 1.5 and 50 bar, more preferably between 2 and 10 bar and even more preferably between 3 and 8 bar. Whilst still under pressure the material is mixed to incorporate the nitrogen as dissolved gas and/or dispersed bubbles not visible to the unaided eye. The fat based confectionery material with a continuous fat phase is then expanded by being discharged at a lower pressure, typically atmospheric pressure. Depending on the nature of intended product, the fat based confectionery material with a continuous fat phase may be discharged in a number of fashions, for example into a mould, or layered between wafers. The density of the material at this point is in the range of 0.6 to 1.0 g/cm³.

In a second step the molten pre-aerated confectionery material with a continuous fat phase is cooled and solidified under a reduced pressure. The temperature in the vacuum box being preferably comprised between −10° C. and 20° C. and more preferably between 12° C. and 16° C. and the pressure being preferably between 1 to 100 mbar and more preferably between 10 to 80 mbar. During this step the small nitrogen or equivalent gas bubbles increase in size, the confectionery material swells, and densities as low as 0.1 to 0.2 g/cm³ are obtained. This represents 84 to 92% of the volume being enclosed gas. Once the confectionery material has solidified sufficiently to maintain a solid structure it can be returned to atmospheric pressure and removed from the cooling system. Typically this second step takes between 15 and 20 minutes.

Optionally, during the first 2 to 5 minutes of the cooling process the pressure can be raised and then reduced again. This is particularly effective in achieving lower densities. For example, the pressure may be reduced to 20 mbar over the first 2 minutes of cooling, held for 10 seconds and then increased to atmospheric pressure before being reduced once more to 20 mbar.

### EXAMPLES

The invention will now be described with reference to the following examples which are not intended to limit the scope of the invention.

### Example 1

### Effect of Different Gasses

A milk chocolate, refined to a d90 of 30 μm (90% of the particles by weight being smaller than 30 μm) with 30.5% total fat, 45.5% sugar and 0.46% lecithin and 0.50% polyglycerol polyricinoleate as emulsifiers was tempered and then aerated using an R&D scale Mondomix™ aeration system Type A05. A series of three different gasses were used. The settings on the Mondomix™ unit were as follows:

Cylinder head pressure: 10 bar gauge

Mondomix™ input pressure: 8 bar gauge

Set mixing head pressure: 7 bar gauge

Actual mixing head pressure: 6 bar gauge

Gas flow: 120 on rotameter (about 20 l/hr)

Chocolate flow: 419 g/min when chocolate has 0.8 g/ml density

Pump speed: 300 rpm

Mixing head speed: 200 rpm

Chocolate temperature: 28.2° C.

The aerated chocolate produced by the Mondomix™ was deposited into a mould which was then transferred to a vacuum box equipped with a water cooling system at 10° C. Once the chocolate was inside the box, the pressure was reduced to 20 mbar which caused the chocolate to expand further. The chocolate remained in the vacuum box at a pressure of 20 mbar for 20 minutes during which time the chocolate temperature had dropped to 13° C. and the chocolate had set.

The chocolate was removed from the vacuum box and its density measured by water displacement (average of 5 values). The mass of aerated chocolate was noted (m_{f}), placed in a glass cylinder filled with water at 20° C., and corked. The weight was noted as mₐ. The weight of the container filled with water alone was also noted (m_{c}). Knowing the water density to be 0.998 gcm⁻³ at 20° C. [Lide D. R. (Ed.). Handbook of Chemistry and Physics, 80th ed. CRC Press, 1999], the density of aerated chocolate was calculated as

$${ρ}_{f} = \frac{{ρ}_{w} \times {m}_{f}}{( {m}_{f} + {m}_{c} - {m}_{a} )} \qquad ( 1 )$$

where ρ_{w} is the density of water (gcm⁻³) and m_{f} is the mass of aerated chocolate (g)

The process was performed three times, with different gasses fed into the Mondomix™; carbon dioxide, nitrogen and argon. For both nitrogen and argon, the aerated chocolate exiting the Mondmix™ contained tiny bubbles, not readily detected by the unaided human eye. In the case of carbon dioxide, the aerated chocolate exiting the Mondmix™ contained larger bubbles which were clearly visible.

With carbon dioxide the chocolate produced at the end of the process had an open fragile structure and the final chocolate had a density of 0.320 g/cm³. The aerated chocolate produced at the end of the process using nitrogen had a low density of 0.180 g/cm³ but a robust structure. The aerated chocolate produced at the end of the process using argon was very similar to that produced with nitrogen, its density was measured as 0.178 g/cm³.

### Example 2

The process of example 1 was repeated with a milk chocolate having a fat content of 37.5% and a sugar content of 41%, but with 0.46% lecithin as the only emulsifier. The gas used was nitrogen. The final density achieved was 0.188 g/cm³

### Example 3

The mean bubble size of the chocolates in example 1 were measured using X-ray tomography. This is a non-destructive and non-invasive technique so it is possible to examine the microstructure of the aerated chocolate samples without physically cutting the chocolate into sections which may destroy the structure. The instrument used was a third-generation cone-beam X-Ray CT (Department of Soil Science, The University of Reading) scanner, which is described in detail by Jenneson et al. (2002) [Jenneson P M, Gilboy W B, Morton E J, Gregory, P J, 2002, An X-ray micro-tomography system optimised for the low-dose study of living organisms. Applied Radiation and Isotopes 58: p. 177-181]. X-rays (Source: Oxford XTF5011) in a conical beam (0.1 Gy radiation dose) are passed through a chocolate cylinder (2.1 cm in diameter, 2.6 cm in length) and its attenuation is measured by an image intensifier (Hamamatsu, C7336). Using relative attenuation values, the chocolate column is reconstructed in 100 μm slices using built-in software (fan-beam Shepp-Logan filtered-back projection algorithm, Barrett and Swindell, 1981 [Barrett, H H and Swindell W, 1981, Radiological Imaging. New York: Academic Press, p. 307-398]).

The reconstructed slices were used to visualize bubble sections using Image Pro™ Plus software (Media Cybernetics, Silver Spring, Md. 20910, USA) to determine bubble section area and diameter. The bubble section diameter measured thus does not represent the true bubble diameter, because bubbles can be sliced off-centre at any cross section. The section diameter can therefore be smaller than the spherical bubble diameter. This analysis of bubble sections at various cross sections is however relevant to the sensory response of the product. Image-Pro™ Plus (Version 4.5) program was calibrated using a micrometer to determine the number of pixels per measured length of the micrometer. The diameter of each bubble section was then determined by the software. For each processing conditions, five individual cross sections (0.2, 0.6, 1, 1.4 and 1.8 cm in height), each having an area of 1.65 cm², were examined to determine the ensemble mean bubble section diameter, the standard deviation, relating to the bubble size spread, and the number of bubbles.

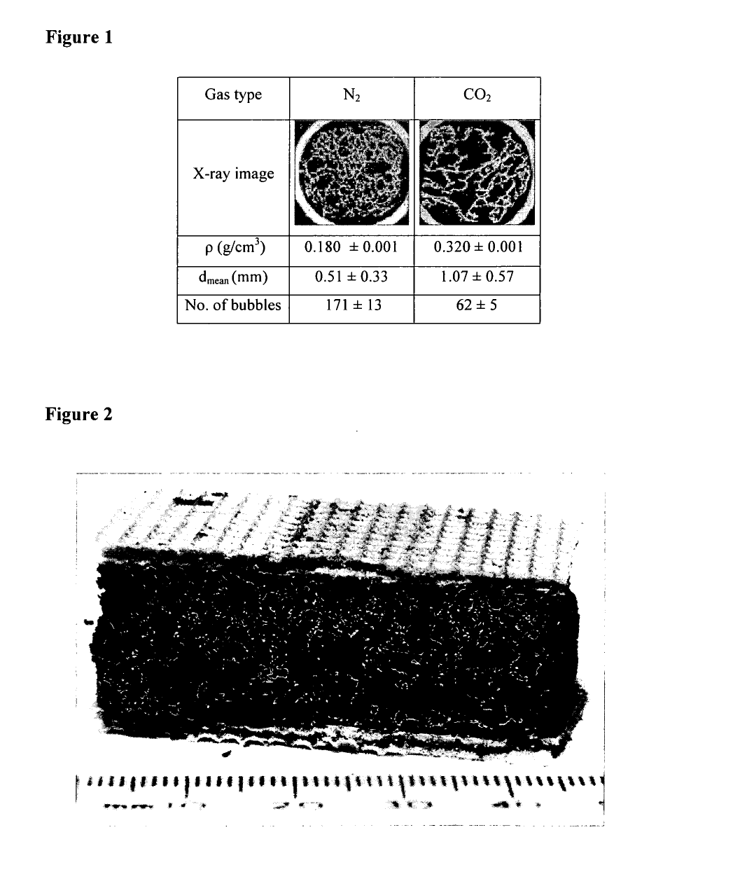

X-ray tomography images of the chocolate of example 1 are shown in FIG. 1. The chocolate aerated with nitrogen is on the left and that aerated with carbon dioxide is on the right.

1. A highly aerated fat based confectionery material with a continuous fat phase having a density of less than 0.2 g/cm³ and equal to or greater than 0.1 g/cm³ and which maintains its shape and can be moulded.

2. A highly aerated fat based confectionery material with a continuous fat phase according to claim 1 having a mean bubble section diameter is of between 0.3 and 0.7 mm.

3. A highly aerated fat based confectionery material with a continuous fat phase according to claim 2 wherein less than 10% of the volume is occupied by spaces having a volume of greater than 3 mm³.

4. A highly aerated fat based confectionery material according to claim 1 wherein 80-100% of the fat phase is cocoa butter and butter oil.

5. A confectionery product comprising a highly aerated confectionery material with a continuous fat phase having a density of less than 0.2 g/cm³ and equal to or greater than 0.1 g/cm³ and which maintains its shape and can be moulded.

6. An ice cream product comprising a highly aerated confectionery material with a continuous fat phase having a density of less than 0.2 g/cm³ and equal to or greater than 0.1 g/cm³ and which maintains its shape and can be moulded.

7. A process for producing a highly aerated confectionery material with a density between 0.1 to 0.2 g/cm³ by comprising the step:
1) aerating a confectionery material by dispersing and/or dissolving a gas using an elevated pressure and then reducing the pressure to obtain bubbles in the confectionery material of a size not readily detected by an unaided human eye;
2) submitting the aerated confectionery material to a further reduction in pressure in order to expand the small bubbles; and
3) solidifying the confectionery material by cooling while maintaining the reduced pressure.

8. A process according to claim 7 wherein the temperature of the confectionery material used in step 1) is between 22° C. to 42° C.

9. A process according to claim 7 wherein the elevated pressure used in step 1) is between 1.5 and 50 bar.

10. A process according to claim 7 wherein the confectionery material has a continuous fat phase.

11. A process according to claim 10 wherein the confectionery material is tempered.

12. A process according to claim 7 wherein the pressure is reduced in step 2) to a pressure of between 1 to 100 mbar.

13. A process according to claim 7 wherein the temperature of the confectionery material used in step 1) is between 25° C. to 37° C.

14. A process according to claim 7 wherein the temperature of the confectionery material used in step 1) is between 27° C. to 33° C.

15. A process according to claim 7 wherein the gas is nitrogen.
